(19) United States
(12) Patent Application Publication
(10) Pub. No.: US 2004/0000227 A1
(43) Pub. Date: Jan. 1, 2004

(54) Machine for clearing land mines

(76) Inventor: Harry Einstein, Kingston, RI (US)

Correspondence Address: Harry Einstein, 98 Parkwood Drive, Kingston, RI, 02881, US

(21) Appl. No.: 10/384,234

(22) Filed: Mar. 10, 2003

Related U.S. Application Data
(60) Provisional application No. 60/362,919, filed on Mar. 11, 2002.

(51) Int. Cl. B64D 1/04; F41F 5/00

(52) U.S. Cl. 89/1.13

(57) ABSTRACT

A self contained, affordable, riding operator controlled machine for safely discharging land mines in farm lands and other accessible areas. The operator is well protected by heavy steel plates and sits 10 feet behind the mine discharge. The mine explosion is directed away from the operator. The heavy steel structure of the machine is designed to withstand the explosive force of anti-personnel land mines. Should an anti-tank mine be encountered, some damage would probably occur, but the operator should be unharmed. The machine (prototype) is designed to clear a 4 foot wide path and clear 1 acre in 2 to 4 hours depending upon the ground conditions. If desired, the described machine could be remotely operated. Such operation would be desired where anti-tank mines or heavy concentration of unexploded ordinance is anticipated.

### BACKGROUND

The use of land mines, in particular anti-personnel, is a deadly legacy of the 20 th century. There are currently estimated to be 127 million land mines in 88 countries world wide with 26,000 people killed or injured annually. (Estimate by U.S. General Accounting Office) The practice of planting them has slowed down in recent years but little has been accomplished in their removal or in discharging them harmlessly. There has been little success in removing this threat.

Most mines unless removed or discharged can remain active for decades As much as ⅓ of the arable land in many less developed countries can be cultivated because of land mines planted during numerous wars prevalent in these countries. Land mines are cheap, costing from about $3 to $15.00 each. The present cost of removal can run from $200 to more than $1,000 Per mine safely disposed of. The archaic method of locating and defusing land mines is the cause of many deaths and injuries

Most of the current efforts are in locating the hidden or buried mines. The several dozens of mine types, made of plastic, metal and even wood, makes the practice difficult and dangerous. Discovery is only part of the problem. Current operations are to uncover and manually defuse, remotely fire an explosive charge on the mine or remotely activate a flame device to to destroy the mine. All these operations are difficult and dangerous. The mine clearing machine of this invention is designed to safely discharge land mines by multiple strikes on the land in every square inch in its path.

### DESCRIPTION: (WITH REFERENCE TO DRAWINGS)

The mine discharging section shows a rectangular bar with end journals to which are affixed rows of ‘strings’ of hinged flat (flailing) plates (or heavy chain) which fly outward by centrifugal force and repeatable strike the earth. The ‘hinged’ plates are shown flat in the drawings, but conttoured plates could be more efficient. Additionally, ‘spikes’ could be incorporated on the outer (last) plates of the strings to help break up the soil. Rotation is provided by an hydraulic motor. The power source is an internal combustion engine driving an hydraulic pump. The same power system is utilized for powering the machine's main wheels. Individual hydraulic valves serve to steer the machine on land/road travel by varying hydraulic output to the wheels. Pneumatic wheels with heavy treads are preferred. Use of automotive type wheel chains can increase traction. An alternative are steel wheels with steel ‘ears’ as was common on early farm tractors.

The machine is supported by 2 front wheels and a single free wheeling swiveling wheel which is designed to be raised or lowered hydraulically for desired land engagement and to enable the machine to be self loaded on a trailer or truck.

Safety for the driving operator is provided by 3 separate high tensile steel plates between the operator and the explosive charge, in addition to a safety glass enclosed cabin.

### BRIEF DESCRIPTION OF THE DRAWINGS

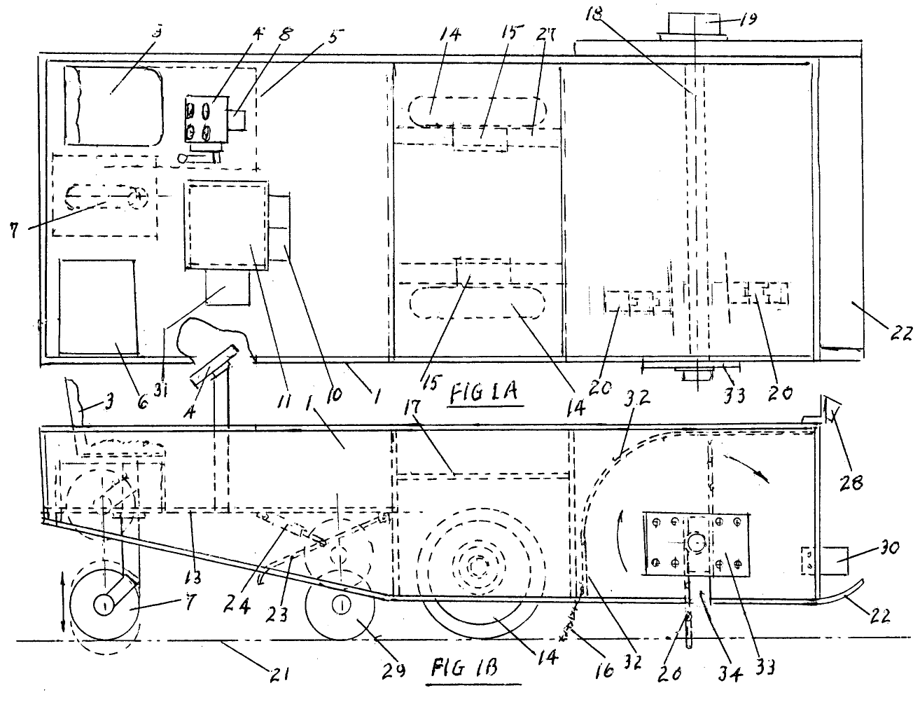

FIG. 1 A is a top view of the demining machine.

FIG. 1 B is a side view of the demining machine.

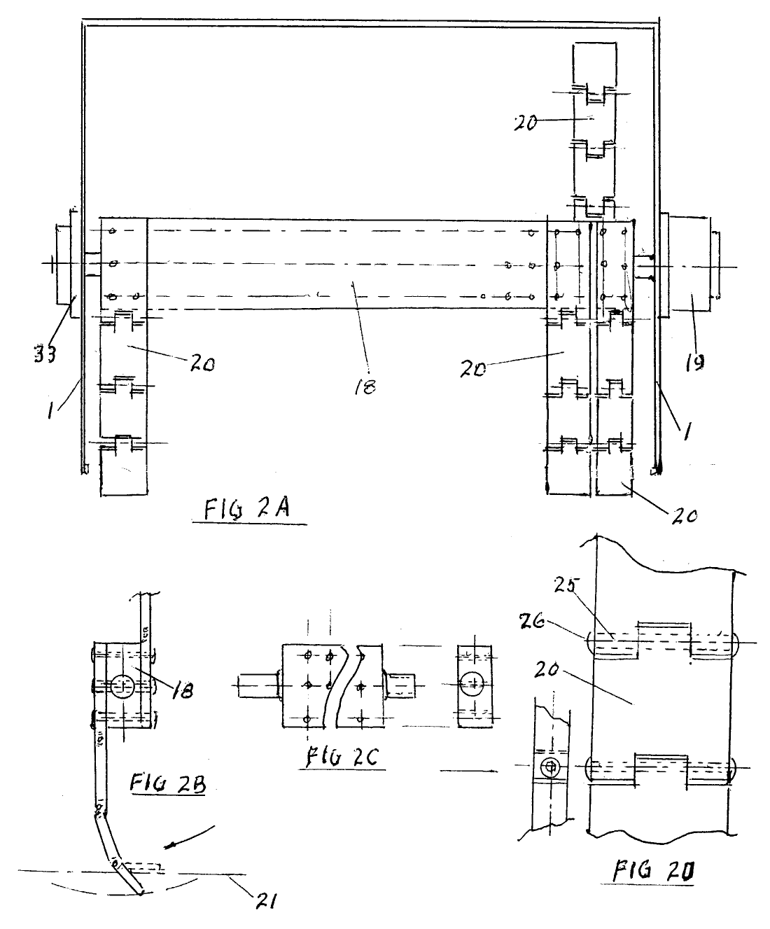

FIG. 2 A is front view of the demining machine showing ‘strings’ (4 of many)of flailing plate strings attached to the flailing bar.

FIG. 2B is an end view of the flailing bar with flailing ‘strings’.

FIG. 2C is a side view of the flailing bar

FIG. 2D is a face view of a section of the flailing ‘strings’

### DESCRIPTIONS OF THE MACHINE COMPONENTS

Item 1 is the main frame of a prototype constructed of high tensile Steel plate.

Item 2 is the steel cover plate.

Item 3 is a shock mounted operator'seat

Item 4 is the operator's control console

Item 5 is a plastic or glass operator's shield. (Shown as dotted line)

Item 6 is a hydraulic tank

Item 7 is a swiveling rear wheel with vertical adjustment.

Item 8 are the hydraulic (valve) controls.

Item 9 is the operator's swivel wheel height control.

Item 10 is the hydraulic pump

Item 11 is the internal combustion engine.

Item 12 is a steel shield.

Item 13 is a steel floor under the operators position

Item 14 are the drive wheels.

Item 15 are the hydraulic wheel motors.

Item 16 is a Steel mesh shield to help confine the explosive blast.

Item 17 is the driving wheels compartment cover.

Item 18 is the supporting bar for the flailing plates

Item 19 is the hydraulic motor for turning the supporting bar (18)

Items 20 are the strings of flailing plates.

Item 21 is the land reference line

Item 22 is a skid to enable the machine to pass on rough terrain.

Item 23 is a agricultural accessory and a secondary demining tool Shown in the retracted position.

Item 24 is the tine rack operating piston

Items 25 are the hinge pins for the flailing plates

Items 26 are the retaining screws for the hinge pins 25

Items 27 are the hydraulic motor supports

Item 28 is a remote observing camera. The monitor, not shown Would be on the operator's console

Item 29 is a cultivating disk rack (or other add-on equipment

Item 30 is a mount for additional equipment, trimmers, etc.

Item 31 is an electric generator as desired

Item 32 is a curved steel shield to add some control of the explosive force

Item 33 is a bearing (flailing bar) mounting plate

Item 34 is a slot to enable the flailing bar assembly to be easily removed for servicing.

1. Having described my invention, what I now claim is:
A tractor type machine for discharging land mines in situs in agricultural and other land which machine with accessories can be utilized for various agricultural operations singlarly or simultaneously

2. The machine of claim 1, where the machine is supported by 2 hydraulic wheels and a swiveling wheel.

3. The machine of claims where the 2 hydraulic wheels are individually controlled for land movement steering and braking.

4. The machine of claim 2 where the rear swivering wheel can be vertically adjusted for the desired land engagement and raised up to allow the machine to be driven up a ramp on a trailer or truck.

5. The machine of claim 1, where the front section contains an hydraulic motor driven flailing unit consisting of “strings” of hinged steel plates affixed to a rotating steel bar.

6. The machine of claim 1, where the rear underside of the demining machine is designed to mount various agricultural attachments: tillers, cultivators and rakes, which rakes can also serve as a back-up demining tool to the primary flailing unit should a land mine be missed by the flailing unit.
